(19) United States
(12) Patent Application Publication
(10) Pub. No.: US 2014/0114979 A1
(43) Pub. Date: Apr. 24, 2014

(54) METHOD AND APPARATUS FOR CLASSIFYING COMMODITIES ON E-COMMERCE PLATFORM

(71) Applicant: TENCENT TECHNOLOGY (SHENZHEN) COMPANY LIMITED, Shenzhen (CN)

(72) Inventor: Junyu LIU, Shenzhen (CN)

(73) Assignee: TENCENT TECHNOLOGY (SHENZHEN) COMPANY LIMITED, Shenzhen (CN)

(21) Appl. No.: 14/144,479

(22) Filed: Dec. 30, 2013

Related U.S. Application Data
(63) Continuation of application No. PCT/CN2012/078557, filed on Jul. 12, 2012.

(30) Foreign Application Priority Data
Aug. 3, 2011 (CN) 201110220792.X

(51) Int. Cl. G06F 17/30

(52) U.S. Cl. CPC G06F 17/30713
USPC 707/740

(57) ABSTRACT

Disclosed are a method and apparatus for classifying commodities on an e-commerce platform. The method includes: setting a classification for each commodity according to a property of the commodity; setting one or more attributes for each classification according to the category; setting at least one attribute value for each attribute according to the attribute; generating a category map according to a category map generation sequence, and a mapping relationship between the classification and attribute value, and categories and sub-categories in the category map, and using the category map as a commodity classification result. According to the embodiments of the present disclosure, by setting a classification-attribute system on the background of an e-commerce website, a category map is adaptively constructed; in this way, the category map is adaptively generated according to the classification and attribute value.

This application is a U.S. continuation application under 35 U.S.C. §111(a) claiming priority under 35 U.S.C. §§120 and 365(c) to International Application No. PCT/CN2012/078557, filed Jul. 12, 2012, which claims the priority benefit of Chinese Patent Application No. 201110220792.X, filed Aug. 3, 2011, the contents of which are incorporated by reference herein in their entirety for all intended purposes.

### TECHNICAL FIELD

The present disclosure relates to the e-commerce field, and in particular, to a method and apparatus for classifying commodities on an e-commerce platform.

### BACKGROUND

With the development of e-commerce technologies, more and more people choose to buy their desired commodities over the Internet, sitting at homes. It is a very critical issue to precisely classify mass commodities such that users can precisely and conveniently search for their desired commodities.

Commodities on an e-commerce website are classified according to the categories of the commodities. The category refers to a classified catalog of the commodity, and the current category system is a classification system established in advance according to level and grade. The category system defines dependency between commodities and most detailed catalog (leaf category). The leaf category forms a category map with its upper-layer category and sub-category, providing users with an access to the e-commerce website. Users can find their target commodities all the way through the category path.

During the implementation of the present disclosure, the inventor finds that the prior art has at least the following problems:

Since the category system is generated in advance, and is strongly coupled to the commodities and leaf categories, it is extremely complicated to sub-divide a leaf category or introduce a new category, and management of the category lacks flexibility. In addition, one commodity can only pertain to one category, whereas users usually hold different knowledge on the attribute of one commodity. Therefore, during search of a commodity, users probably fail to find the corresponding category from categories based on their own knowledge, resulting in low search efficiency and thus poor user experience.

### SUMMARY

To enable a more flexible classification of commodities on an e-commerce platform, embodiments of the present disclosure provide a method and apparatus for classifying commodities on an e-commerce platform. The technical solutions are as follows:

An embodiment of the present disclosure provides a method for classifying commodities on an e-commerce platform. The method includes:

setting a classification for each commodity according to a property of the commodity;

setting one or more attributes for each classification according to the classification;

setting at least one attribute value for each of the attributes according to the one or more attributes;

generating a category map according to a category map generation sequence, and a mapping relationship between the classification and attribute value, and categories and sub-categories in the category map, and using the category map as a commodity classification result.

Preferably, the setting one or more attributes for each classification according to the classification includes:

setting the attribute of the classification according to a common attribute of all commodities in the category.

An embodiment of the present disclosure provides an apparatus for classifying commodities on an e-commerce platform. The apparatus includes:

a first setting module, configured to set a classification for each commodity according to a property of the commodity;

a second setting module, configured to set one or more attributes for each classification according to the classification;

a third setting module, configured to set at least one attribute value for each of the attributes according to the one or more attributes; and

a classifying module, configured to generate a category map according to a category map generation sequence, and a mapping relationship between the classification and the at least one attribute value, and categories and sub-categories in the category map, and use the category map as a commodity classification result.

The technical solutions provided in the embodiments of the present disclosure achieve the following beneficial effects: By setting a classification-attribute system on the background of an e-commerce website, a foreground category map is adaptively constructed; in this way, the foreground category map is flexibly generated according to the classification and attribute value; and additionally a variety of category maps may be generated according to different usages and scenarios, such that the flexibility of category construction is greatly improved and the category management efficiency is enhanced. Meanwhile, by using the generated category map, users are able to easily find their desired commodities.

### BRIEF DESCRIPTION OF THE DRAWINGS

For a better understanding of the technical solutions in the embodiments of the present disclosure, the accompanying drawings for illustrating the embodiments are briefly described below. Apparently, the accompanying drawings in the following description illustrate only some embodiments of the present disclosure, and persons of ordinary skill in the art can derive other accompanying drawings from these accompanying drawings without any creative efforts.

FIG. 1 is a schematic flowchart of a method for classifying commodities on an e-commerce platform according to one embodiment of the present disclosure;

FIG. 2 is a schematic flowchart of a method for classifying commodities on an e-commerce platform according to another embodiment of the present disclosure;

FIG. 3 illustrates a classification manner in the method for classifying commodities on an e-commerce platform according to another embodiment of the present disclosure;

FIG. 4 illustrates a classification manner in the method for classifying commodities on an e-commerce platform according to another embodiment of the present disclosure;

FIG. 5 illustrates a classification manner in the method for classifying commodities on an e-commerce platform according to another embodiment of the present disclosure; and

FIG. 6 is a schematic structural diagram of an apparatus for classifying commodities on an e-commerce platform according to another embodiment of the present disclosure.

### DETAILED DESCRIPTION

To make the objectives, technical solutions, and advantages of the present disclosure clearer, the embodiments of the present disclosure are described in detail below with reference to the accompanying drawings.

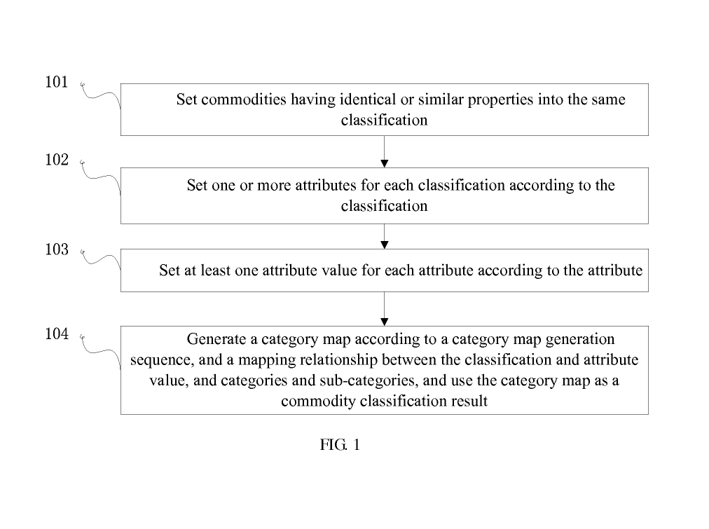

According to one embodiment a method for classifying commodities on an e-commerce platform is provided, a flowchart of which is illustrated in FIG. 1. The method includes the following steps:

step 101: setting commodities having identical or similar properties into the same classification;

step 102: setting one or more attributes for each classification according to the classification;

step 103: setting at least one attribute value for each attribute according to the attribute;

step 104: generating a category map according to a category map generation sequence, and a mapping relationship between the classification and attribute value, and categories and sub-categories, and using the category map as a commodity classification result.

According to the embodiments of the present disclosure, by setting a classification-attribute system on the background of an e-commerce website, a foreground category map is adaptively constructed; in this way, the foreground category map is freely generated according to the classification and attribute value; and additionally a variety of category maps may be generated according to different usages and scenarios, such that the flexibility of category construction is greatly improved and the category management efficiency is enhanced. Meanwhile, by using the generated category map, users are able to easily find their desired commodities.

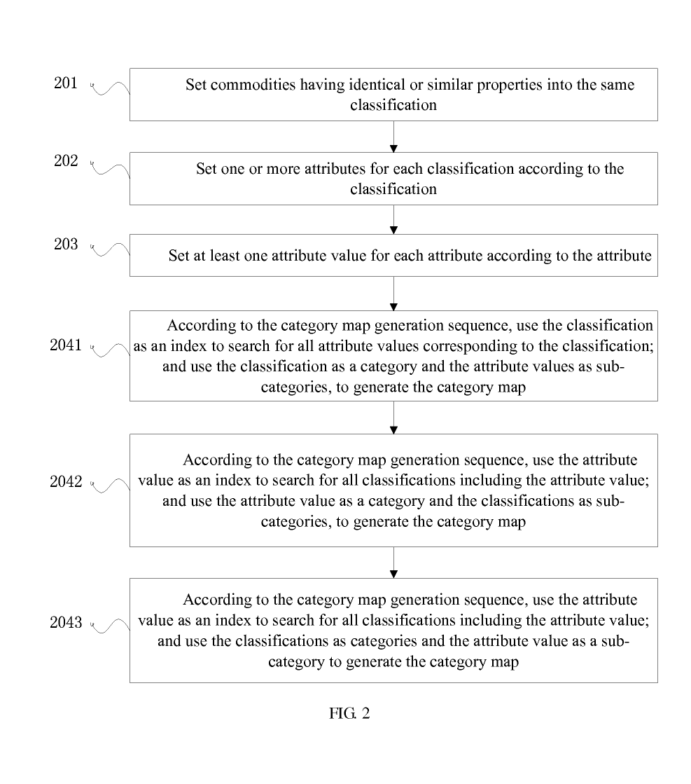

According to another embodiment a method for classifying commodities on an e-commerce platform is provided, a flowchart of which is illustrated in FIG. 2. The method includes the following steps:

Step 201: Setting commodities having identical or similar properties into the same classification.

Specifically, on the background of an e-commerce website, to construct a framework for commodity classification, commodities having similar attribute and function are grouped into the same classification according to perceptual knowledge and cognitive habits about the commodities, and all commodities are grouped into the corresponding classifications according to the attributes thereof. The relationship between the classifications is unique, no dependency exists between the classifications, and each classification has its own attribute set. For example, “mobile phone” can be used as a classification, and “digital camera” can be used as a classification.

Furthermore, since different users hold different understandings for the same commodity, the same commodity may pertain to different classifications to coincide with the fact that different people hold different knowledge about the same commodity. In this way, the same commodity can be found in different classifications, which improves user experience. For example, the mobile phone may also pertain to the classification “communication equipment”, the two categories “communication equipment” and “mobile phone” do not contain totally identical commodities and attributes, and the “communication equipment” further includes commodities such as fixed telephone and walkie-talkie; therefore, the mobile phone may also be grouped into the classification “communication equipment”.

The setting commodities having identical or similar properties into the same classification specifically includes:

setting a classification for each commodity according to a property of the commodity.

It should be noted that in this embodiment, the property of the commodity may be the function of the commodity. For example, flip-top mobile phones and bar-type mobile phones are both used for communication, and therefore, they have the identical property and can be grouped into the same classification “communication equipment”; MP3 is used to play music files, MP4 is used to play music files and video files, MP3 and MP4 are both used to play multimedia files; therefore, they are considered as having the similar property and thus can be grouped into the same classification “audio video device” or “multimedia player”.

Step 202: Setting one or more attributes for each classification according to the classification.

Specifically, after the commodities are classified, the attribute of a classification is set according to the common attribute of all the commodities in the classification, for depicting the feature of the commodity in one aspect. Users' knowledge about a commodity is multi-dimensional. Therefore, one commodity may be understood in multiple different aspects. For example, under the classification “mobile phone”, different mobile phones have different attributes. The attribute of a mobile phone may be appearance, communication mode, brand, camera pixel, or the like.

After the classification and attribute of a commodity are determined, the commodity inherits all the attributes of the classification, and values of the attributes are determined one by one when a commodity releaser releases the commodities on an e-commerce website.

Step 203: Setting at least one attribute value for each attribute according to the attribute.

Specifically, each of the attributes corresponds to one or more attribute values which depict the features of the corresponding commodity and are used for further classification of the commodity. Each specific commodity may be classified to each attribute according to the attribute value.

Using the example in the above step as an example, in terms of appearance, the attribute value may be bar-type, flip-top, slide, rotation . . . , or the like; in terms of communication mode, the attribute value may be GSM, CDMA, or the like; in terms of brand, the attribute may be Nokia, Motorola, Sony Ericsson, or the like; and in terms of camera pixel, the attribute value may be 100 w, 200 w, 500 w, or the like.

Step 204: Generating a category map according to a category map generation sequence, and a mapping relationship between the classification and attribute value, and categories and sub-categories, and using the category map as a commodity classification result.

Specifically, the classification-attribute system is a system or structure for managing commodity classification on the background, where the commodities having the identical attribute are used as a set, and the classification is used as a set of the same classification of commodities. The commodities in the set may be considered as having different attributes from different perspectives, and specific commodities will be found according to the different attribute values of the corresponding attributes. A category-sub-category system is a tree-shaped map for exhibiting commodity classifications and specific commodities on the e-commerce website.

In the embodiments of the present disclosure, the category map on the foreground, i.e., a mapping relationship between category and sub-categories, may be correspondingly generated by the classification-attribute system on the background. To be specific, the category may be correspondingly generated by using the classification, and the sub-category may be correspondingly generated by using the attribute value; or the category may be correspondingly generated by using the attribute value, and the sub-category may be correspondingly generated by using the classification corresponding to the attribute value; or the classification corresponding to the attribute value may be used as the category, and the attribute value may be used as the sub-category of each category.

The classification-attribute system is like a warehouse, where all commodities are stored in fixed places. The category-sub-category system is like shelves for housing commodities, which may be freely adjusted according to users' requirements. The category map is generated according to a mapping relationship between the category-sub-category system and the classification-attribute system, i.e., a mapping relationship between classifications and attribute values, and categories and sub-categories. The generated category map is used as a commodity classification result.

A plurality of category maps may be generated and applied in different scenarios according to user preference and management requirements, such that users are capable of finding desired commodities over different paths. Specifically, the category map may be generated according to the classification and the attribute value sequence thereof; or may be reversely generated according to the attribute value and all the classifications including the attribute value. In this way, the classifications can be deployed in multiple perspectives, achieving more flexibility.

It should be noted that, in this embodiment, the category map generation sequence includes: from classification to attribute value, and from attribute value to classification.

Therefore, step 204 may be implemented in the following three manners:

Manner 1: According to the category map generation sequence, the classification is used as an index to search for all attribute values corresponding to the classification; and the classification is used as a category and the attribute values are used as sub-categories, to generate the category map.

This manner is used when the category map generation sequence is “from classification to attribute value”.

In a category map generated by using the classification as an index, the classification is used as a category, each attribute corresponding to the classification is used as a classification identifier of each branch of the category map, and the attribute values corresponding to the attributes are used as sub-categories in the branch. As illustrated in FIG. 3, a category map is generated by using the classification “mobile phone” as a category, the attributes as the classification identifiers of branch of the category map, and attribute values of the attribute as the sub-categories.

Manner 2: According to the category map generation sequence, the attribute value is used as an index to search for all classifications including the attribute value; and the attribute value is used as a category and the classifications are used as sub-categories, to generate the category map.

This manner is used when the category map generation sequence is “from attribute value to classification”.

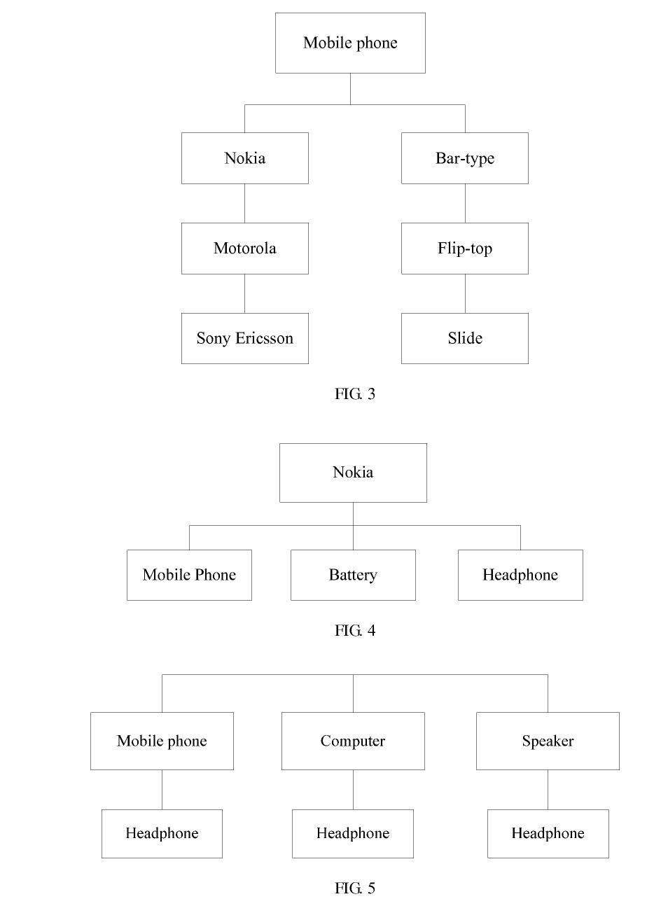

In a category map generated by using the attribute value as an index, the attribute value is used as a category, and all the classifications including the attribute value are used as sub-categories of the attribute value. As illustrated in FIG. 4, the attribute value “Nokia” of the attribute “brand” is used as an index to search for all classifications including the attribute value “Nokia”; a category map is generated by using the attribute value “Nokia” of the attribute “brand” as a category and all the found classifications as sub-categories.

Manner 3: According to the category map generation sequence, the attribute value is used as an index to search for all classifications including the attribute value; and the classifications are used as categories and the attribute value is used as a sub-category to generate the category map.

This manner is used when the category map generation sequence is “from attribute value to classification”.

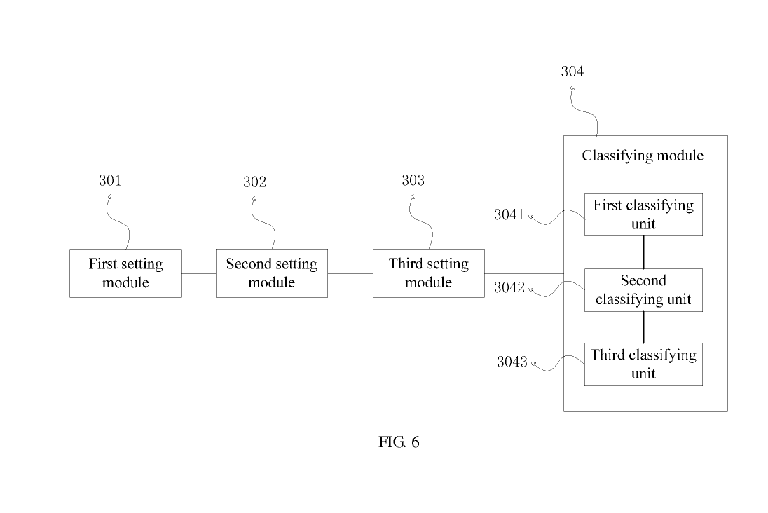

In a category map generated by using the attribute value as an index, all classifications including the attribute value are used as categories, and the attribute value is used as a sub-category. As illustrated in FIG. 5, the attribute value “headphone” of the attribute “accessory” is used as an index to search for all classifications including the attribute value “headphone”; a category map is generated by using all the found classifications as categories and the attribute value “headphone” as a sub-category.

According to the embodiments of the present disclosure, by setting a classification-attribute system on the background of an e-commerce website, a foreground category map is adaptively constructed; in this way, the foreground category map is adaptively generated according to the classification and attribute value; and additionally a variety of category maps may be generated according to different usages and scenarios, such that the flexibility of category construction is greatly improved and the category management efficiency is enhanced. Meanwhile, by using the generated category map, users are able to easily find their desired commodities.

According to another embodiment an apparatus for classifying commodities on an e-commerce platform is provided, a structural diagram of which is illustrated in FIG. 3. The apparatus includes:

a first setting module 301, configured to set commodities having identical or similar properties to the same classification

a second setting module 302, configured to set one or more attributes for each classification according to the classification;

The second setting module 302 is specifically configured to:

set the attribute of the classification according to a common attribute of all commodities in the classification.

a third setting module 303, configured to set at least one attribute value for each attribute according to the attribute; and

a classifying module 304, configured to generate a category map according to a category map generation sequence, and a mapping relationship between the classification and attribute value, and categories and sub-categories, and use the category map as a commodity classification result.

The classifying module 304 specifically includes:

a first classifying unit 3041, configured to: when the category map generation sequence is “from classification to attribute value”, use the classification as an index, search for all attribute values corresponding to the classification, use the classification as a category and use the attribute values as sub-categories to generate the category map;

a second classifying unit 3042, configured to: when the category map generation sequence is “from attribute value to classification”, use the attribute value as an index, search for all classifications corresponding to the attribute value, use the attribute value as a category and use the classifications as sub-categories to generate the category map; or

a third classifying unit 3043, configured to: when the category map generation sequence is “from attribute value to classification”, use the attribute value as an index, search for all classifications including the attribute value, use the classifications as categories and use the attribute value as a sub-category of each category to generate the category map.

According to the embodiments of the present disclosure, by setting a classification-attribute system on the background of an e-commerce website, a foreground category map is adaptively constructed; in this way, the foreground category map is adaptively generated according to the classification and attribute value; and additionally a variety of category maps may be generated according to different usages and scenarios, such that the flexibility of category construction is greatly improved and the category management efficiency is enhanced. Meanwhile, by using the generated category map, users are able to easily find their desired commodities.

A person skilled in the art should understand that all or part of steps of the preceding methods may be implemented by hardware or hardware following instructions of programs. The programs may be stored in a computer readable storage medium. The storage medium may be a read only memory, a magnetic disk, or a compact disc-read only memory.

Described above are merely preferred embodiments of the present disclosure, but are not intended to limit the present disclosure. Any modification, equivalent replacement, or improvement made without departing from the spirit and principle of the present disclosure should fall within the protection scope of the present disclosure.

1. A method for classifying commodities on an e-commerce platform, comprising:
setting a classification for a commodity according to a property of the commodity;
setting one or more attributes for each classification according to the classification;
setting at least one attribute value for each of the attributes according to the one or more attributes; and
generating a category map according to a category map generation sequence, and a mapping relationship between the classification and the at least one attribute value, and categories and sub-categories in the category map, and using the category map as a commodity classification result.

2. The method according to claim 1, wherein the setting one or more attributes for each classification according to the classification comprises:
setting the attribute of the classification according to a common attribute of all commodities in the classification.

3. The method according to claim 1, wherein the generating a category map according to a category map generation sequence, and a mapping relationship between the classification and the at least one attribute value, and categories and sub-categories in the category map, comprises:
searching for all attribute values corresponding to the classification using the classification as an index, using the classification as a category and using the attribute values as sub-categories to generate the category map when the category map generation sequence is from classification to attribute value.

4. The method according to claim 1, wherein the generating a category map according to a category map generation sequence, and a mapping relationship between the classification and the at least one attribute value, and categories and sub-categories in the category map, specifically comprises:
searching for all classifications corresponding to the attribute value using the attribute value as an index, using the attribute value as a category and using the classifications as sub-categories to generate the category map, when the category map generation sequence is from attribute value to classification; or
searching for all classifications comprising the attribute value using the attribute value as an index, using the classifications as categories and using the attribute value as a sub-category of each category to generate the category map, when the category map generation sequence is from attribute value to classification.

5. An apparatus for classifying commodities on an e-commerce platform, comprising:
a first setting module, configured to set a classification for each commodity according to a property of the commodity;
a second setting module, configured to set one or more attributes for each classification according to the classification;
a third setting module, configured to set at least one attribute value for each of the attributes according to the one or more attributes; and
a classifying module, configured to generate a category map according to a category map generation sequence, and a mapping relationship between the classification and the at least one attribute value, and categories and sub-categories in the category map, and use the category map as a commodity classification result.

6. The apparatus according to claim 5, wherein the second setting module is specifically configured to:
set the attribute of the classification according to a common attribute of all commodities in the classification.

7. The apparatus according to claim 5, wherein the classifying module specifically comprises:
a first classifying unit, configured to: search for all attribute values corresponding to the classification using the classification as an index, use the classification as a category and use the attribute values as sub-categories to generate the category map, when the category map generation sequence is from classification to attribute value.

8. The apparatus according to claim 5, wherein the classifying module specifically comprises:
a second classifying unit, configured to: search for all classifications corresponding to the attribute value using the attribute value as an index, use the attribute value as a category and use the classifications as sub-categories to generate the category map, when the category map generation sequence is from attribute value to classification; or
a third classifying unit, configured to: search for all classifications comprising the attribute value using the attribute value as an index, use the classifications as categories and use the attribute value as a sub-category of each category to generate the category map, when the category map generation sequence is from attribute value to classification.

9. A non-transitory computer-readable storage medium with an executable program stored thereon, wherein the program, when executed by at least one processor, causes a computer to perform operations comprising:
setting a classification for a commodity according to a property of the commodity;
setting one or more attributes for each classification according to the classification;
setting at least one attribute value for each of the attributes according to the one or more attributes; and
generating a category map according to a category map generation sequence, and a mapping relationship between the classification and the at least one attribute value, and categories and sub-categories in the category map, and using the category map as a commodity classification result.

10. The non-transitory computer-readable storage medium according to claim 9, wherein the setting one or more attributes for each classification according to the classification comprises:
setting the attribute of the classification according to a common attribute of all commodities in the classification.

11. The non-transitory computer-readable storage medium according to claim 9, wherein the generating a category map according to a category map generation sequence, and a mapping relationship between the classification and the at least one attribute value, and categories and sub-categories in the category map, comprises:
searching for all attribute values corresponding to the classification using the classification as an index, using the classification as a category and using the attribute values as sub-categories to generate the category map, when the category map generation sequence is from classification to attribute value.

12. The non-transitory computer-readable storage medium according to claim 9, wherein the generating a category map according to a category map generation sequence, and a mapping relationship between the classification and attribute value, and categories and sub-categories in the category map, specifically comprises:
searching for all classifications corresponding to the attribute value using the attribute value as an index, using the attribute value as a category and using the classifications as sub-categories to generate the category map, when the category map generation sequence is from attribute value to classification; or
searching for all classifications comprising the attribute value using the attribute value as an index, using the classifications as categories and using the attribute value as a sub-category of each category to generate the category map, when the category map generation sequence is from attribute value to classification.
